(19) United States
(12) Patent Application Publication
(10) Pub. No.: US 2012/0139737 A1
(43) Pub. Date: Jun. 7, 2012

(54) PHOTOVOLTAIC MODULE AND COMBINATION OF SEVERAL PHOTOVOLTAIC MODULES

(75) Inventors: Karl-Heinz Gross, Unterwittstadt (DE); Martin Kohler, Michelbach a.d. Bilz (DE); Werner Belschner, Michelbach a.d. Bilz (DE); Matthias Barie, Kupferzell (DE)

(73) Assignee: WUERTH SOLAR GMBH & CO. KG, Schwaebisch Hall (DE)

(21) Appl. No.: 13/309,871

(22) Filed: Dec. 2, 2011

(30) Foreign Application Priority Data
Dec. 2, 2010 (DE) 10 2010 053 020.4

(51) Int. Cl. H02H 3/00; G08B 21/00

(52) U.S. Cl. 340/635; 361/78

(57) ABSTRACT

A photovoltaic module including a plurality of single photovoltaic cells is described. The photovoltaic module includes an electric connection device having power connections for outputting generated photovoltaic energy to a consumer network and an electric cutout device having cutout terminals at the power connections of the electric connection device and at least one safety circuit breaker through which the power connections of the electric connection device may be disconnected electrically from the consumer network. The electric cutout device includes a trigger device which is formed with a thermal sensitivity and/or a smoke sensitivity, which is connected to the safety circuit breaker in such a way that upon detection of a temperature and/or of smoke exceeding a predetermined threshold, the safety circuit breaker electrically disconnects the power connections of the electric connection device from the consumer network. A combination of several such photovoltaic modules is also described.

### CROSS-REFERENCE TO RELATED APPLICATIONS

The present application claims priority from German Application DE 10 2010 053 020.4, filed on Dec. 2, 2010.

### FIELD OF THE INVENTION

The present invention relates to a photovoltaic module comprising a plurality of photovoltaic cells as well as a combination of several such photovoltaic modules, each for connection to a building electricity network for supplying consumers or electrically operated components of a building with electric power or for feeding electric power into a regional consumer network.

### BACKGROUND

Photovoltaic modules are fundamentally known and are being employed for the generation of electricity for a consumer network. To this end, photovoltaic modules are installed partly on or at buildings, in particular on or at residential buildings on the roofs and/or the facades thereof. Such photovoltaic modules on buildings may serve both for assisting the building electricity network and feeding into a regional consumer network. Herefor the known photovoltaic modules are provided with an electric connection device through which the respective photovoltaic module may be electrically connected to a consumer network.

From DE 10 2008 003 272 A1 a monitoring unit for photovoltaic modules is known, wherein inside a connection box of the photovoltaic module a function module circuit board is arranged on which a multiplicity of function monitoring modules are arranged. Function modules may be a temperature sensor and a deactivation module which manages central deactivation of the photovoltaic module.

From DE 10 2005 018 173 A1 a method of securely deactivating photovoltaic installations is known. Triggering may be effected through smoke, water, gas sensors or other switching means.

From DE 10 2008 029 491 A1 a protection device comprising a power deconnection device for deconnecting power-carrying lines is known. Separation may be carried out mechanically or by pyrotechnical means.

From DE 20 2006 007 613 U1 a photovoltaic installation comprising at least one photovoltaic element for mounting on roofs or vacant areas is known which comprises a thermal cutout in the electric connection line between the photovoltaic element and the electric interchange point.

From DE 10 2010 008 542 A1 a photovoltaic protection apparatus is known. For a protection against electric shocks in an emergency, a separating device in operational connection with a sensor means is provided which does, for example, transmit a trigger signal to the disconnecting means in consequence of a fire. The sensor device moreover may be a smoke sensor.

From DE 20 2007 001 648 U1 another apparatus for deenergizing photovoltaic installations in the event of a fire is known.

From DE 10 2007 032 605 A1 a photovoltaic installation comprising at least one photovoltaic element as well as electric connection lines for providing electric power is known, wherein the current flow and/or the voltage and/or the electric connection at at least one photovoltaic element and/or within at least one photovoltaic element may be controlled, thereby making it possible to completely remove lethally hazardous voltage values from the latter or deenergize it, e.g. in an emergency.

From DE 10 2006 060 815 A1 a solar energy generating installation is known to comprise a switching element which deenergizes the associated photovoltaic module in the absence of an enabling signal and activates it in the presence of the enabling signal.

### SUMMARY

Various embodiments of the present invention provide a photovoltaic module as well as a combination of several photovoltaic modules that is/are capable in an emergency, in particular in a fire situation, of deenergizing the power connections of the photovoltaic module as rapidly, safely and effectively as possible in order to secure the building for the rescue operation.

According to one aspect of some of the embodiments of the invention a photovoltaic module including a plurality of individual photovoltaic cells is provided, the photovoltaic module comprising:
an electric connection device having power connections or power connection lines for outputting generated photovoltaic energy to a consumer network,
an electric cutout device having cutout terminals at the power connections of the electric connection device and at least one safety circuit braker whereby the power connections of the electric connection device may be disconnected electrically from the consumer network, wherein the electric cutout device comprises a trigger device which is formed with a thermal sensitivity and/or a smoke sensitivity and which is connected to the safety circuit breaker in such a way that upon detection of a temperature and/or of smoke exceeding a predetermined threshold, the safety circuit breaker electrically disconnects the power connections of the electric connection device from the consumer network.

The trigger device having a thermal sensitivity and/or a smoke sensitivity may in particular be an actuation device adapted to assume at least two actuation states and in particular is realized with a sensor device in such a way that upon detection of a temperature higher than a predetermined threshold, and/or upon detection of smoke contents or smoke constituents in the air, the content or concentration of which is higher than a predetermined threshold, the trigger device changes from a first actuation state to a second actuation state, wherein the second actuation state is realized such that the power connections of the electric connection device are electrically disconnected from the consumer network.

Thus, the manner of functioning of previously known photovoltaic modules may be influenced in the event of fires in the buildings on which the photovoltaic modules are installed, such that in an emergency, particulary in a fire situation, the power connections are deenergized as quickly, safely and effectively as possible in order to secure the building for the rescue operation, for photovoltaic modules provide electric energy based on the irradiation of light, in particular sunlight. This power generation is not stopped by a fire in the building but continues as light keeps being irradiated. Even if an inverter connected downstream from the photovoltaic module is deactivated, the power connections of the photovoltaic modules and the downstream connection lines carry current as a result. Consequently there exists a risk of electric shock upon contact with these lines. Because the power connections to the consumer network extend through the house, they are thus energized even after the fuses of the building electricity network turned off or were deactivated. For cases of emergencies such as fires, rescue personnel and in particular firefighters are instructed i. a. to electrotechnically secure the building, i.e., to deactivate the cutout means of this network in order to avoid injury due to electric shocks. Deactivation of the fuse thus causes the rescue personnel to falsely believe that all electric lines in the building are deenergized and thus not dangerous. As this is, however, not true for the power connections of the photovoltaic modules in accordance with the above description, the latter constitute a particular danger as they are not perceived to pose a risk any more.

In the case of known actuation switches on the photovoltaic modules for deenergizing the power connections of the photovoltaic modules this must, however, be done consciously. In accordance with various embodiments of the invention, it is not necessary for a rescue service member to make his way to the photovoltaic modules prior to the beginning of the rescue operation in order to operate this switch to thereby deenergize the lines inside the building. Accordingly, this decisively shortens the time period until the beginning of the rescue operation and presents the further advantage that no person has to make his way to the photovoltaic modules which are in most cases arranged on the roof of a building or on the facade thereof.

The photovoltaic module of various embodiments of the invention comprises a plurality of single photovoltaic cells and an electric connection device having power connections for outputting photovoltaic energy generated by the photovoltaic cells to a consumer network for electric energy. Such a consumer network may, for example, be an internal network of a building. It is furthermore possible for the consumer network to be a public power network into which the power of the photovoltaic module is fed. These power connections comprise: at least one power connection interface for connecting the respective photovoltaic module to connection lines leading to the connection points of the consumer network, in order to deliver the electric power generated by the photovoltaic cells, or the electric current generated by the photovoltaic cells, to the consumer network. For the case that several photovoltaic modules are electrically coupled with each other in the module, the power connections also comprise connection lines for electrically connecting single photovoltaic modules to each other. In addition an inverter may furthermore be provided which converts the DC current generated by the photovoltaic module into AC current and feeds it into the consumer network. The inverter may thus be part of the connection device and may in particular also be provided inside a module service box or a module service cabinet.

Furthermore, a photovoltaic module in accordance with embodiments of the invention comprises an electric cutout device having cutout terminals on or integrated in the power connections and in particular at least one power connection interface of the electric connection device and comprising a safety circuit breaker. By means of this safety circuit breaker the power connections of the electric connection device may be electrically disconnected from the consumer network. In this way, decoupling of the photovoltaic module takes place directly at the power connections which are disposed, e.g., inside a module connection box on the roof of a building or on the facade thereof directly next to the photovoltaic system. The safety circuit breaker may, for example, have the form of a relay which receives control signals for the desired switching condition from a control device, e.g. from the control device of the photovoltaic module. When the safety circuit breaker has the form of a relay, it is possible that the trigger device also comprises a relay circuit which in the normal condition supplies the relay with a minimum current to thereby keep the safety circuit breaker of the cutout device closed. The relay thus includes a self-holding function. The safety circuit breaker may then be executed in such a way that the relay circuit is interrupted with the aid of the trigger device, for example on the basis of signals from sensors and/or through the use of temperature-sensitive materials in a corresponding switch element, so that the relay ceases to be supplied with the minimum current and the safety circuit breaker opens. In this way the photovoltaic module is thus secured and disconnected from the consumer network.

In a photovoltaic module in accordance with embodiments of the invention, there may further be provided a trigger device of the electric cutout device which comprises a device and in particular a sensor having thermal sensitivity and/or smoke sensitivity and is coupled with the safety circuit breaker in such a way that upon detection of a temperature higher than a predetermined threshold and/or of smoke having an intensity higher than a predetermined threshold, the safety circuit breaker electrically disconnects the electric connection between the respective photovoltaic module and the consumer network or between the power connections of the electric connection device and the consumer network. Disconnecting the power connections from the consumer network has the consequence that any subsequent lines of the consumer network or of the building that are provided for electric connection of the photovoltaic module are in this way deenergized and thus secured for the rescue operation. Here the expressions “thermal sensitivity” and “smoke sensitivity” should be understood to the effect that the trigger device is realized so as to be capable of qualitatively and/or quantitatively detecting a thermal variation and/or a smoke intensity, or may respond on the basis of a thermal variation and/or a smoke intensity. In order to realize a thermal sensitivity it is possible to use thermal sensors, for example, whereas for example a smoke alarm may be employed for realizing a smoke sensitivity. In principle, the trigger device may be realized immediately as a part of the cutout device or may also be realized, at least partly, to be physically spaced apart from it.

In this regard some embodiments shall be discussed in detail further below. The single photovoltaic cells of a photovoltaic module may be connected both in series, as a so-called string, but also in parallel with each other.

In other words, a photovoltaic module of various embodiments of the present invention is capable of automatically separating the electric connection between the power connections and the consumer network, as it were, in a predefined temperature and/or smoke situation. If an elevated temperature of, e.g., more than 100° C. and/or generation of smoke is detected through sensing means by the trigger device, then this may indicate a certain probability of an emergency, in particular a fire, in the vicinity of the photovoltaic module in question. In this case the coupling of the trigger device with the safety circuit breaker serves to automatically open the latter, to thereby electrically separate the connection between the power connections of the connection device and the consumer network. In other words, by opening the safety circuit breaker the building is secured for the rescue operation with regard to the lines of the photovoltaic module. In contrast with the known systems, this does not basically only bring about the desired securing of the building, but such securing is moreover also achieved automatically, i.e. without an active intervention on the part of rescue personnel. In the ideal case, securing of the photovoltaic module thus has already taken place when the rescue personnel arrive at the site.

A photovoltaic module in accordance with embodiments of the invention may be developed further to the effect of the trigger device being an integral component part of the safety circuit breaker and/or the cutout device. The trigger device may thus advantageously also be located in the module connection box of the photovoltaic module. “Integral component part” should here be understood to the effect that a part of the cutout device and/or a part of the safety circuit breaker is executed so as to enable it to operate as a trigger device. Various embodiments in this regard shall be described in more detail in the following. One advantage that may be achieved through this integral execution is the very compact design. As a result it is possible to integrally provide the trigger device and the cutout device inside a common housing, for example inside the module connection box. This serves to save space and above all costs, for it does away with the necessity of arranging any additional lines between the trigger device and the cutout device.

In one embodiment of the photovoltaic module with integral execution of the cutout device and the trigger device it may be advantageous if the trigger device comprises a component made of bimetal which directly or indirectly opens the safety circuit breaker in the event of a temperature increase.

Direct opening is possible, e.g., when the safety circuit breaker itself, i.e. in particular the switching means thereof, is at least partly made of bimetal. This bimetal part is executed in such a way as to move from the closed to the opened position as soon as a certain temperature is exceeded, and stay in this opened position while this temperature prevails. The thermal sensitivity is thus furnished through the provision of a bimetal component which is capable of defining the precise opening temperature of the safety circuit breaker by way of the explicit combination of materials and the geometrical arrangement inside the safety circuit breaker. This direct integral execution is particularly advantageous with regard to its space demand. As there is no need for a control device transmitting a measured temperature to the safety circuit breaker, this embodiment is moreover particularly safe in terms of its functionality.

Indirect opening of the switch is possible, for instance, if the bimetal component is arranged such that it may deform under the influence of temperature, to move the safety circuit breaker to its open position in the course of the path of this deformation. Such indirect opening is equally possible without any additional control device, so that this embodiment may also be considered to be particularly safe with regard to its functionality. As a result of the connection with the bimetal component, the safety circuit breaker is thus either urged or pulled into the open position.

According to one embodiment of the present invention it may furthermore be provided that the trigger device comprises a component or an actuating member of shape memory material which, in a first actuation state, establishes an electric connection in the power lines or power connections, and in a second actuation state directly or indirectly opens the electric connection in the powerlines or power connections. The shape memory material may, e.g., be a shape memory alloy or a shape memory polymer. In a shape memory alloy, the shape change or allotropic conversion is based on the temperature-dependent lattice conversion of two different crystal structures of a material. Shape memory polymers are synthetic materials present a shape memory effect, to thus seemingly be capable of “remembering” their former external shape despite an intense change of shape having taken place in the meantime. Shape memory polymers may comprise two components. The first component is an elastic polymer forming a spring element, and the second component a curable wax that may arrest the spring element in any desired shape. Upon heating of the shape memory polymer, the wax softens and can no longer resist the force of the spring element, so that the shape memory polymer again assumes its original shape.

As regards direct and indirect opening, reference is presently made to the corresponding descriptions for the embodiment comprising a bimetal component, for the arrangement and the manner of functioning are essentially identical when a shape memory material is used. Shape memory material, and thus for instance a shape memory alloy, also has thermal sensitivity. This sensitivity is expressed through the geometrical change of the shape of the material under the influence of temperature. Thus it is possible, e.g., to use wires or rods of shape memory material that change their shape under the influence of temperature. As the change of shape under the influence of temperature is due to modifications of the microstructure in the material, namely, the transition of martensite to austenite and the accompanying compacting of the microstructure, the length of such wires or rods changes in the process. A rod as an immediate component part of the safety circuit breaker will thus contract under the influence of heat and thereby, in the presence of a corresponding geometrical arrangement of the contacts of the safety circuit breaker, open the connection to the consumer network. Indirect opening may be brought about by urging the safety circuit breaker if a substantially inflexible rod is used, or by pulling the safety circuit breaker to the opened position if a wire of shape memory material is used. One advantage of the use of shape memory material is the abrupt comportment of this material. In this way it is also possible to ensure abrupt opening of the safety circuit breaker, without any transition impairing the speed and thus the safety of the switching operation.

Particularly in embodiments without sensors, i.e. if the safety circuit breaker and/or the cutout device comprising the trigger device are executed as an integral design, it may be advantageous if a latch for the safety circuit breaker is provided that keeps it in the opened position following the opening, independently of any changes in the temperature and/or smoke situation. It may thus be advantageous in a photovoltaic module of various embodiments of the invention if the electric cutout device comprises a latch for the safety circuit breaker which latches the safety circuit breaker in the open position following its opening in order to interrupt the connection of the power connections of the electric connection device to the consumer network. In other words, the safety circuit breaker is locked in the secured position and thus in the open position, with such latch preventing a subsequent reestablishment of the connection of the power connections to the consumer network.

In a preferred embodiment it is provided that the latch comprises a latch means presenting an approach slope across which a distal end of the cutout switch may be moved.

This movement during opening of the cutout switch causes the latch means to be displaced from its home position. In order to make sure that the latch means will be returned to the latching position following sufficient opening of the cutout switch, a latch spring may be provided which presents a direction of force contrary to the direction of movement of the latch means during opening of the safety circuit breaker. Once the safety circuit breaker has reached the opened position, the latch means latches it in the opened position, whereby automatic closing of the conducting connection to the consumer network 100 is precluded. Among other things, this presents the advantage that the automatically occurred securing can not be released automatically.

Furthermore it is preferably provided that the latch comprises a release function for manually releasing the latch. This may be achieved by a portion of the latch means protruding from a housing of the cutout device. Through the intermediary of this protruding part of the latch means, the latter may actively be moved against the latch spring, to again release the safety circuit breaker in this way.

A release switch may also be provided whereby the latch may be released, to thereby close the safety circuit breaker again. Owing to the latch the safety circuit breaker remains in the opened position even if the values for smoke and/or or temperature drop to values lower than the triggering values. This may be the case, e.g., if in the event of a fire in a building the fire extinguishing operation has been started, whereby the building is cooled at least partly. Without the latch there would accordingly be a risk of the safety circuit breaker automatically closing again, and thus a risk of securing of the lines in the building being cancelled again even during an ongoing rescue operation as the building is cooling down. Otherwise, the risk of electric shock would accordingly present itself anew during ongoing rescue operations.

Moreover it may be advantageous in a photovoltaic module of various embodiments of the invention if the trigger device comprises at least one sensor that is capable of qualitatively or quantitatively converting smoke and/or temperature into a sensor signal, and the coupling of the safety circuit breaker and the trigger device is implemented through a signal line and an actuation device for the safety circuit breaker. Accordingly, in this embodiment at least one part of the trigger device is separate from the cutout device and thus also from the safety circuit breaker. In particular the sensitive part of the trigger device is provided in the form of a sensor which transmits its sensor signal via a signal line to the cutout device. In such embodiments it may be advantageous if an actuation device for the safety circuit breaker is provided, whereby the safety circuit breaker may at least be moved to the opened position. Providing a sensor which may be disposed separate from the cutout device allows to achieve the advantage that it is possible to use standard components of correspondingly low pricing for the sensor. Moreover the dimension of the cutout device may be reduced further, for less components need to be arranged inside a common housing. In this way a multi-purpose utilization of sensors is furthermore possible. Thus there is a possibility that sensors and/or or building control systems already existing in a building may be used in order to serve as sensors for the trigger device. This allows better coverage of the building with sensors for the trigger device of the photovoltaic module and at the same time a cost reduction for the photovoltaic module of various embodiments of the invention. For a trigger device comprising sensors, a central or even decentralized control device may then be provided which relays signals received from the sensors to further components but also to a photovoltaic module in accordance with embodiments of the invention, and optionally processes such signals for the photovoltaic module.

In the framework of various embodiments of the present invention, it may moreover be advantageous if at least one sensor of the trigger device is arranged physically spaced apart from the safety circuit breaker. In particular it may be advantageous if, in a photovoltaic module in accordance with embodiments of the invention, the at least one sensor physically spaced apart from the safety circuit breaker is disposed in the vicinity of the connected consumer network. In other words, the sensor is advantageously disposed in an area passed through by the lines of the consumer network. In the case of a building electricity network as the consumer network, as a place for the sensor this is in particular the core of the building, i.e. the area that is not only the possible site of a fire but in which the rescue personnel will moreover preferably move about during the rescue operation. As a result, the sensor of the trigger device may still trigger the cutout device if an impairment due to a fire has not occurred yet in the location of the cutout device, particularly in the location of the photovoltaic cells. As photovoltaic cells are frequently installed on the roofs of buildings, it is hereby ensured that the cutout device will also trigger in a situation where a fire has occurred inside the building. In this way the triggering time of the trigger device is made to be earlier, so that in particular triggering of the cutout device will already have taken place when the rescue personnel arrive at the site, i.e. even before the commencement of the rescue operation.

In advantageous embodiments it is possible for the trigger device to comprise at least one explosive cutout. Such an explosive cutout is one possibility of triggering the cutout device and taking the safety circuit breaker to its opened position.

In order to achieve a design of the photovoltaic module as compact as possible and in particular utilize previously existing components in photovoltaic systems, it may furthermore be advantageous if the trigger device and/or the cutout device are at least partly arranged inside a module connection box of the photovoltaic module. In this way the location and the housing of the previously existing module connection box may be used for arranging the components in accordance with embodiments of the invention of the photovoltaic module.

According to a further aspect of various embodiments of the invention, a combination of several photovoltaic modules is provided, each of which is executed in accordance with an embodiment of the invention, wherein at least one cutout device of a photovoltaic module for disconnecting the respective associated power connection is functionally coupled with at least one cutout device of at least one further photovoltaic module in such a way that upon activation of one of the cutout devices for disconnecting the respective associated power connection, the respective other cutout device for disconnecting the respective associated power connection is subsequently also activated, so that the combination of several photovoltaic modules in particular does not deliver any electric power whenever an activation of even one of the cutout devices has taken place.

In this way a redundancy with regard to the cutout devices is obtained.

Here, in particular at least one cutout device of each photovoltaic module is adapted to be connected via at least one respective discrete electric signal line to at least one cutout device of each further photovoltaic module of the combination of photovoltaic modules, with the at least one discrete electric signal line being electrically and functionally connected in such a way to a cutout device of a first photovoltaic module and being electrically and functionally connected in such a way to a cutout device of a second photovoltaic module that upon activation of one of the cutout devices for disconnecting the respective associated power connection that are interconnected via the signal line, the respective other cutout device for disconnecting the respective power connection associated to it is activated, so that the combination of several photovoltaic modules does not output electric power if an activation of even one of the cutout devices has taken place.

By this embodiment of the invention, high safety for the deactivation of a combination of modules is achieved at low technical complexity. This deactivating device may be realized without, or substantially without, electronic components if the separation of the coupling of the respective safety devices is effected by means of mechanical and/or simple electrical components. For example, the cutout device may be embodied as a switch mechanically biased into its open position, electrically connected to the output line of the photovoltaic cells, and comprising a contact element, which switch is released from a locked position wherein the switch is held in its closed position relative to the connection line to the released position, by the movement of a detent, so that the switch comprising the contact element reaches its open position wherein the power connection in electrical connection with the associated connection line is established by way of the contact element.

In one embodiment of the invention it may be provided that only one electrical connection line for coupling the safety devices of these photovoltaic modules is connected between two respective photovoltaic modules. In this case, a safety circuit breaker module may be functionally arranged on each one of the safety circuit breakers, which is connected on the one hand to such a safety circuit breaker and on the other hand to the electrical connection line. Each safety circuit breaker module includes a detection function whereby it detects, through detection of the presence or absence of a current in the electrical connection line or a voltage thereon, whether the safety circuit breaker of the respective other photovoltaic module is in the open position. In addition each safety circuit breaker may include a switching function whereby it takes the respective associated safety circuit breaker to its open position by a corresponding actuation of the detent if the detection function has detected that the safety circuit breaker of the respective other photovoltaic module is in the open position. In this case the electrical connection line is connected to a power source or supplied with power in such a way that the detection function may detect whether voltage or current is present in the electrical connection, to determine in this way the open position of the safety circuit breaker.

Here it may in particular be provided that voltage is applied to the line in the closed condition of a switch, and no voltage is applied to or no electric current is flowing in the line in the open position of the switch, so that the disconnection of the respective power connection takes place on the basis of this condition. In this way better safety of this functionality may be achieved, for a component fault in the safety circuit breaker module can not result in erroneous conclusions in the module.

In an alternative embodiment of the invention it may provided that two electrical connection lines for coupling the safety devices of different photovoltaic modules may be connected between two respective photovoltaic modules. In this case the detection function of one respective photovoltaic module is connected to the switching function of the respective other photovoltaic module. In other respects, the functionality is the same as in the embodiment of the safety circuit breaker module comprising one connection line between two photovoltaic modules.

As an alternative, it may be provided in accordance with some embodiments of the invention that the functional connection of the cutout device of a photovoltaic module to at least one further cutout device of at least one further photovoltaic module takes place via a wireless interface, in particular via zigbee.

In this case the activation of a respective one of the cutout devices for disconnecting the respective power connection associated to it, which are interconnected via the signal line, may take place in accordance with an embodiment of the invention. This may in particular take place through activation of the trigger device by at least one sensor which is integrated in the trigger device in such a way and executed in such a way that based on a qualitative or quantitative detection of smoke exceeding a predetermined intensity and/or temperature higher than a threshold, it generates a sensor signal which places the trigger device in a condition in which the power connection or the power connection line in which the trigger device is integrated, is electrically disconnected in the sense of the activation and thus can no longer send any power to a supply line of a consumer network or to the consumer network. Here it may moreover be provided that the safety circuit breaker and the trigger device are functionally connected to each other via a signal line, and that the trigger device comprises an actuation device which opens the safety circuit breaker based on the generated sensor signal.

In these embodiments it may alternatively or additionally be provided that the cutout device or the trigger device may be operated by means of an external user interface such as a hand-held apparatus and in particular wireless equipment and may thus be activated for disconnecting the connection of a photovoltaic module to a consumer network and/or at least one electrically operated component.

These embodiments enhance the reliability and safety of the entire securing function for cutting the flow of electricity in an output line or connection line, whereby the combination of several photovoltaic modules may be electrically uncoupled from an electric consumer and/or a consumer network.

A further aspect of some embodiments of the present invention relates to a building electricity network for supplying consumers or electrically operated components integrated or located in a building with electric power which, as a consumer network including at least one photovoltaic module in accordance with embodiments of the invention, is electrically supplied with electric power electrically via its connection device. What is particularly advantageous is the arrangement of photovoltaic cells and in particular photovoltaic modules comprising photovoltaic cells on a roof of a building and in particular of a residential building. In this way the safety of such buildings with regard to rescue operations, e.g. in cases of fire, is clearly enhanced and the rescue personnel are protected better during the operation.

In accordance with embodiments of the invention there is furthermore provided a photovoltaic system comprising a combination of several photovoltaic modules and a building electricity network for supplying a building with electric power, which is electrically supplied with electric power by the combination of several photovoltaic modules via its connection device, wherein in the photovoltaic system a status indicating device for indicating the general operating condition, however in particular for the measure of disconnecting the photovoltaic modules from the connection line electrically or by wireless communication is integrated, wherein the disconnection of the respective associated power connection from the building electricity network is carried out in accordance with one or several ones of the following alternatives:
the status indicating device is implemented as a visual indicating device and in particular as a signal lamp or LED, and/or
the status indicating device is implemented as an acoustic indicating device and in particular with a speech module,

wherein the status indicating device in particular comprises a storage battery which is adapted to be charged by the photovoltaic modules during their normal operation.

With the aid of such a status indicating device it is ensured that the status indicating device is capable of conveying status information and in particular emitting an acoustic or visual signal in the absence of any or sufficient daylight.

By the provision of a storage battery and its electric coupling with the modules it is ensured that the status indicating device is operable at any time as regards its energy condition.

The status indicating device may be implemented in a separate or integrated manner: in one, several, or each of the photovoltaic modules, in the one location in which the respective photovoltaic modules may be connected electrically, or on or in the inverter. In particular the status indicating device, e.g. a signal lamp, may also be attached on a service cabinet inside the building. When the status indicating device is embodied as an acoustic indicating device, it may comprise a speech module for indicating the status information in the form of a speech output.

The status indicating device may in particular be implemented functionally in such a way as to provide acoustic and/or visual information when the cutout device is taken into a condition in which the disconnection of a power connection has taken place.

When the photovoltaic system is switched to a condition in which the connection of a power connection has taken place, there may in particular be provided: a first visual display indicating that commanding of this connection of a power connection has taken place by wireless communication, and a second visual display indicating that the connection of a power connection has taken place.

When the photovoltaic system is switched to a condition in which the disconnection of a power connection has taken place, there may in particular be provided: a first visual display indicating that commanding of this disconnection of a power connection has taken place by wireless communication, and a second visual display indicating that the disconnection of a power connection has taken place.

### BRIEF DESCRIPTION OF THE DRAWINGS

The present invention shall in the following be explained through embodiments by referring to the annexed figures, where the used expressions “left”, “right”, “top” and “bottom” relate to the representations of the figures at an orientation in which the reference symbols in the figures can be read normally. In the figures:

FIG. 1 shows a first embodiment of a photovoltaic module in accordance with the invention,

FIG. 2 shows a further embodiment of a photovoltaic module in accordance with the invention,

FIG. 3 shows a further embodiment of a photovoltaic module in accordance with the invention,

FIG. 4a shows an embodiment of a cutout device with safety circuit breaker in the opened position,

FIG. 4b shows the embodiment of FIG. 4a with safety circuit breaker in the closed position,

FIG. 5a shows an embodiment of a cutout device with safety circuit breaker in the opened position,

FIG. 5b shows the embodiment of FIG. 5a with safety circuit breaker in the closed position,

FIG. 6 shows a schematic representation of a possible arrangement of photovoltaic modules of an embodiment of the invention on a building.

### DESCRIPTION

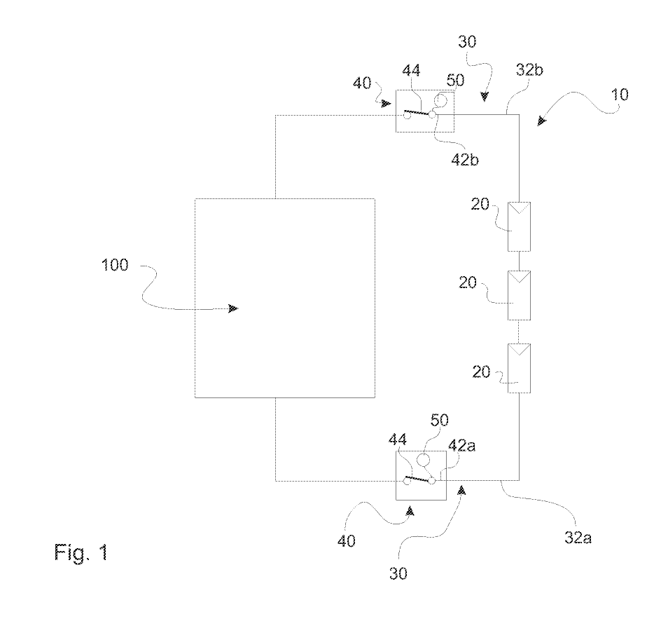

FIG. 1 represents a first embodiment of the photovoltaic module 10 of the invention. In FIG. 1 the photovoltaic module 10 of this embodiment is represented in the situation of use, i.e. at a time when the electric coupling with a consumer network 100 exists. The consumer network 100 may be, for example, an internal network 100b of a building for supplying the building with electric energy. It is also possible that the consumer network 100 is a public power network 100a into which the power generated by the photovoltaic module 10 is fed.

By way of example, the photovoltaic module 10 of this embodiment is equipped with three photovoltaic cells 20 connected in series. It is, however, also possible to combine more than three photovoltaic cells 20 in one photovoltaic module 10.

The photovoltaic module 10 of this embodiment comprises a connection device 30 coupled to the consumer network 100 via two power connections 32a and 32b. To the two power connection devices 32a and 32b there is connected a cutout device 40 which is realized in two parts in the embodiment of FIG. 1. In each one of these parts of the cutout device 40 a safety circuit breaker 44 is provided which is in electrically conducting connection to the power connection devices 32a and 32b via cutout terminals 42a and 42b. The three photovoltaic cells 20, the safety circuit breakers 44 and the consumer network 100 thus represent a serial connection. The respective electrically conducting connection to the consumer network 100 is established by means of this cutout device 40, in particular by means of the safety circuit breaker 44. In order to guarantee this, in the situation of use according to FIG. 1 the two safety circuit breaker 44 are closed and close the corresponding electric circuit between photovoltaic cells 20 and consumer network 100. In particularly simple embodiments it may also be sensible if the cutout device 40 has only one safety circuit breaker 44 which can break the electric circuit between photovoltaic cells 20 and consumer network 100 in one location.

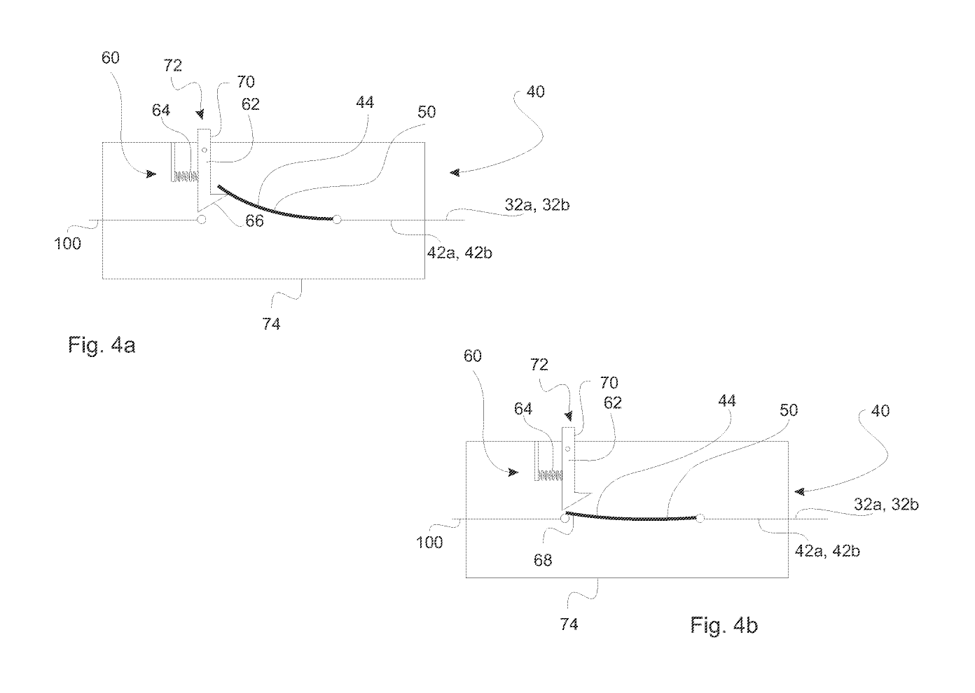

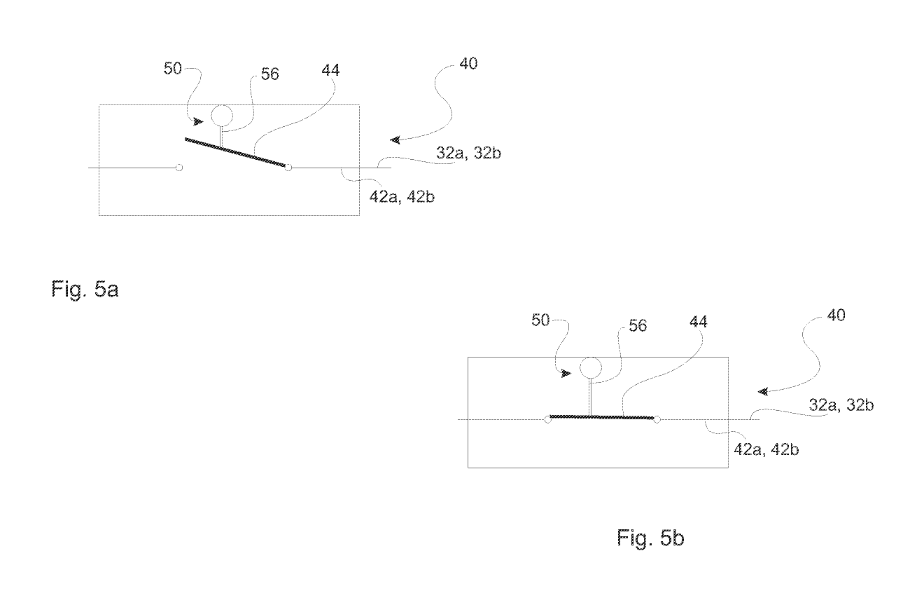

In order to enhance the safety of the photovoltaic module 10 in accordance with an embodiment of the invention, a trigger device 50 is provided for the cutout device 40. In the embodiment of FIG. 1 this trigger device 50 is executed integrally with the cutout device 40 or integrally with the safety circuit breaker 44. Details for such an embodiment may be seen, for example, in the embodiment of FIGS. 4a, 4b, 5a, and 5b that shall be explained in more depth later on. This trigger device 50 has thermal sensitivity and/or smoke sensitivity. This means that upon a detection that a predefined temperature limit has been exceeded and/or upon a quantitative and/or qualitative detection of smoke, the trigger device 50 opens the safety circuit breaker 44 of the cutout device 40 and in this way electrically separates the photovoltaic cells 20 from the consumer network 100. Opened safety circuit breakers 44 are represented in FIGS. 4a and 5a, for example.

The embodiment of FIG. 1 may be provided, e.g., with safety circuit breakers 44 comprising a bimetal component and/or a component of shape memory material.

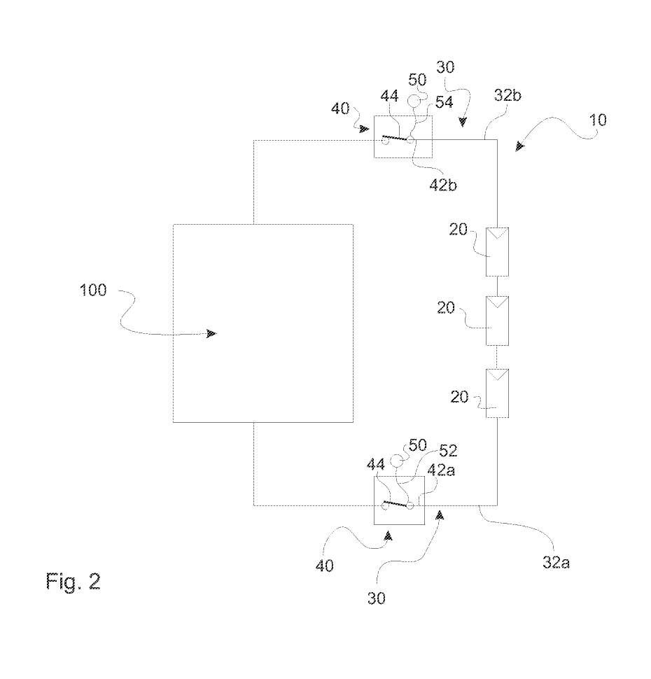

In FIG. 2 a further embodiment of the photovoltaic module 10 in accordance with the invention is represented which is a variation of the embodiment of FIG. 1. In this variation the trigger device 50 is not realized integrally with the cutout device 40 any more, but rather separate from the latter. The trigger device 50 is then coupled via a signal line 54 with the cutout device 40, in particular the safety circuit breaker 44. In this embodiment there is particularly provided an actuation device 56, as is shown schematically in FIGS. 5a and 5b but not shown in the representation of FIG. 2 for reasons of clarity. The trigger device 50 which is equipped, for example, with thermal sensors and/or smoke alarms, is arranged at a distance from the cutout device 40.

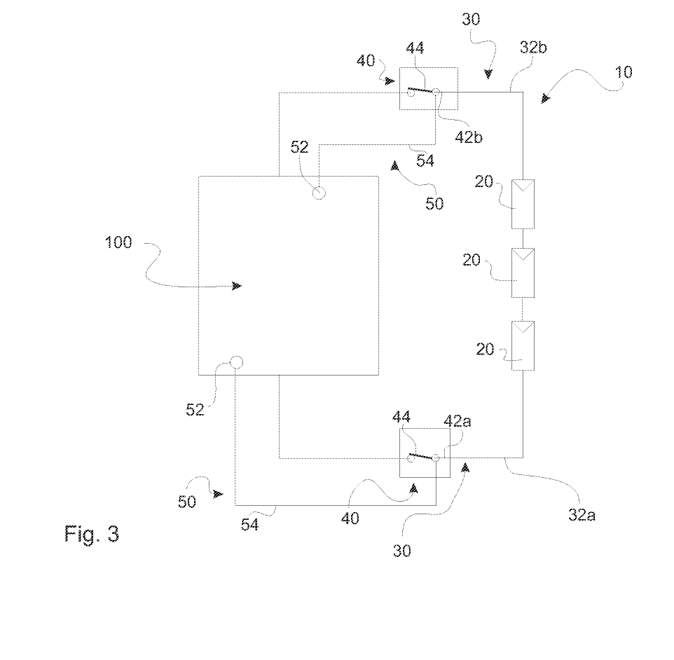

FIG. 3 shows a further embodiment of a photovoltaic module 10 in accordance with the invention as a further variation of the embodiments of FIGS. 1 and 2. In this embodiment the distance between the sensor 52 of the trigger device 50 and the cutout device 40 is clearly greater than in FIG. 2. In particular the sensor 52—or in the case of FIG. 3 the two sensors 52—is/are arranged in the vicinity of the consumer network 100. This means that in an emergency situation such as a fire in the area of the consumer network 100, these sensors 52 are capable of detecting the fire even before it has spread as far as the photovoltaic cells 20. As photovoltaic cells 20 are mostly arranged on roofs of buildings, the desired safety deactivation by the cutout device 40 thus takes place even before the fire has fully spread to the roof or the facade of the building, and thus at a very early point of time, so that the automatic deactivation, i.e. the opening of the safety circuit breaker 44 in particular, has already taken place before the arrival of the rescue personnel.

In FIGS. 4a and 4b an embodiment of a cutout device 40 in accordance with the invention is represented. In this embodiment the trigger device 50 is executed integrally with the cutout device 40, in particular even integrally with the safety circuit breaker 44. The trigger device 40 comprises a bimetal component which represents the entire safety circuit breaker 44 of the cutout device 40 in this embodiment. FIG. 4b shows the situation in the condition of use of the photovoltaic module 10, i.e. with a safety circuit breaker 44 in the closed condition. In this position of the safety circuit breaker 44 an electrically conducting connection between the photovoltaic module 10 and the consumer network 100 and thus via the power connection 32a and 32b and the cutout terminal 42a and 42b has been established.

If, now, an emergency situation such as a fire in a building brings about an elevated temperature, the safety circuit breaker 44 reacts through a shape change of the bimetal. The latter bends upward as a result of the combination of materials and the geometrical arrangement thereof, to thereby sever the electric connection between the cutout terminal 42a, 42b and the consumer network 100. Bending of the safety circuit breaker 100 accordingly interrupts this electrically conducting connection, whereby a building having such a photovoltaic module 10 is secured for a rescue operation with the aim of extinguishing the fire.

By way of example, the embodiment of FIGS. 4a and 4b further comprises a latch or latching device 60 which serves to hold the safety circuit breaker 44 in its opened position following opening, even if the environmental parameters would actually result in renewed closing of the safety circuit breaker 44. Thus, if the temperature drops, for example due to an ongoing firefighting operation by the rescue personnel, the bimetal component of the cutout device 40, in particular a bimetal safety circuit breaker 44, bends back to assume a shape that would again close the connection with the consumer network 100. In order to prevent this in view of the ongoing firefighting operation with the resulting need for continued securing of the building, a latch 60 serves to prevent the safety circuit breaker 44 from closing.

To this end the latch 60 may be executed, for example, as seen in the embodiment of FIGS. 4a and 4b. A latch means 64 is provided with an oblique plane or approach slope 66 along which one end portion or distal end 68 of the safety circuit breaker 44 may move. By this movement the latch means 64 is displaced from its rest position during opening of the safety circuit breaker 44. In the embodiment of FIGS. 4a and 4b this is effected by displacing the latch means 64 to the left. In order to ensure that the latch means 64 will be moved back to the latching position following a sufficient opening of the safety circuit breaker 44, a latch spring 64 is provided which presents a direction of force contrary to the direction of movement of the latch means 64 during opening of the safety circuit breaker 44. Once the safety circuit breaker 44 has reached the opened position, the latch means 64 latches it in the opened position, whereby automatic closing of the electrically conducting connection to the consumer network 100 is precluded.

In order to be able to close the safety circuit breaker 44 again, for instance in the case of a false alarm, the latch 60 may comprise a release function 72 allowing to manually release the latch 60. In the embodiment of FIGS. 4a and 4b this is achieved by portions of the latch means 64 protruding from a housing 74 of the cutout device 40. Through the intermediary of this protruding part 70 of the latch means 64, the latter may actively be moved against the latch spring 62, to again release the safety circuit breaker in this way.

In FIGS. 5a and 5b an embodiment of a cutout device 40 comprising an actuation device 56 is shown. The actuation device 56 is part of the trigger device 50 and in this embodiment acts mechanically on the safety circuit breaker 44. In other words, the actuation device 56 serves to open and/or close the safety circuit breaker 44 in response to a command by the trigger device 50, for example following receipt of a corresponding signal. This may be brought about by urging and/or by pulling the safety circuit breaker 44. The signal for the actuation device 56 may be generated by one or several sensors 52 which is/are part of the cutout device 40 or, as is shown in the embodiments of FIGS. 2 and 3, is/are arranged at a distance from the latter.

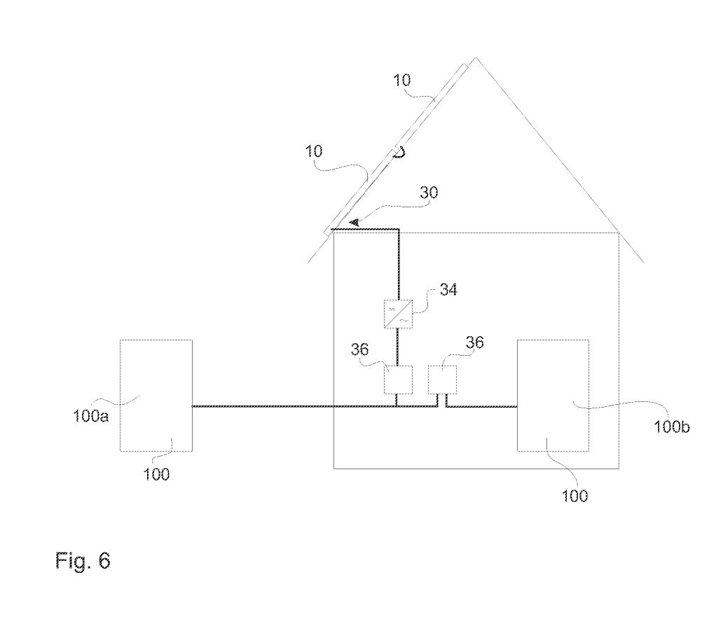

In FIG. 6 a possible arrangement of photovoltaic modules 10 of an embodiment of the invention on a building is represented schematically. In this embodiment the photovoltaic modules 10 are arranged on the roof of a building and are there exposed to irradiated light, e.g. sunlight. The current generated in the photovoltaic cells 20 of the photovoltaic modules 10 due to this irradiation is direct current that is conducted into the building, via the connection device 30 of at least one of the photovoltaic modules 10, and there converted to alternating current by means of an inverter 34. The inverter 34 serves to adapt the generated electric power to the predetermined parameters of the consumer networks 100 being supplied.

In the embodiment of FIG. 6 two different consumer networks 100 are represented in a combined manner. The left-hand consumer network 100 is a public power network 100a into which the power generated by the photovoltaic modules 10 is fed. In order to enable a calculation of the remuneration for the feeding, this power is passed via a protection and counter device 36. In the embodiment of FIG. 6 a further consumer network 100 having the form of a power network 100b internal to the building is additionally provided in the building but may, however, also be provided separately. The photovoltaic modules 10 on the roof of the building are thus also capable of supplying current to the power network 100b in the building. In order to enable detection of the consumption herefor, a protection and counter device is equally provided in the branching toward the internal power network 100b of the building.

The single photovoltaic modules 10 on the roof of the building are individually connected to each other in series in a discrete manner, so that triggering of the electric cutout device 40 of one of the photovoltaic modules 10 is sufficient to place the system of all the photovoltaic modules 10 on the roof of the building in a secured condition in which no electric power is conducted to the inside of the building. Hereby safety is enhanced even further, for a single instance of triggering is sufficient to obtaining securing, and because the system comprised of a plurality of photovoltaic modules 10 is in this way secured redundantly, as it were.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

### LIST OF REFERENCE NUMERALS

10 photovoltaic module
20 photovoltaic cell
30 connection device
32a power connection
32b power connection
34 inverter
36 protection and counter device
40 electric cutout device
42a cutout terminals
42b cutout terminals
44 safety circuit breaker
50 trigger device
52 sensor
54 signal line
56 actuation device
60 latch
62 latch means
64 latch spring
66 approach slope
68 distal end
70 protruding part
72 release function
74 housing
100 consumer network
100a public power network
100b power network internal to a building

What is claimed is:

1. A photovoltaic module comprising a plurality of single photovoltaic cells, the photovoltaic module comprising:
an electric connection device having power connections for outputting generated photovoltaic energy to a consumer network,
an electric cutout device having cutout terminals at the power connections of the electric connection device and at least one safety circuit breaker whereby the power connections of the electric connection device may be disconnected electrically from the consumer network, wherein the electric cutout device comprises a trigger device which is formed with a thermal sensitivity and/or a smoke sensitivity and which is connected to the safety circuit breaker in such a way that upon detection of a temperature and/or of smoke exceeding a predetermined threshold, the safety circuit breaker electrically disconnects the power connections of the electric connection device from the consumer network.

2. The photovoltaic module according to claim 1, wherein the trigger device is an integral component part of the safety circuit breaker and/or the cutout device.

3. The photovoltaic module according to claim 2, wherein the trigger device comprises a component of bimetal which is connected to the safety circuit breaker in such a way that in the event of a temperature increase the trigger device directly or indirectly electrically disconnects the safety circuit breaker.

4. The photovoltaic module according to claim 2, wherein the trigger device comprises a component of shape memory material which is connected to the safety circuit breaker in such a way that in the event of a temperature increase the trigger device directly or indirectly electrically disconnects the safety circuit breaker.

5. The photovoltaic module according to claim 1, wherein the electric cutout device comprises a latching device for the safety circuit breaker which latches the safety circuit breaker in an opened position following the electrical disconnection by opening of the safety circuit breaker in order to interrupt the connection of the power connections of the electric connection device to the consumer network.

6. The photovoltaic module according to claim 5, wherein the latch comprises a latch means presenting an approach slope across which a distal end of the cutout switch is moveable.

7. The photovoltaic module according to claim 5, wherein the latch comprises a release function for manually releasing the latch.

8. The photovoltaic module according to claim 1, wherein the trigger device comprises at least one sensor that, based on a qualitative or quantitative detection of smoke exceeding a predetermined intensity and/or temperature higher than a threshold, generates a sensor signal, wherein the safety circuit breaker and the trigger device are functionally connected to each other via a signal line, and wherein the trigger device comprises an actuation device which opens the safety circuit breaker based on the generated sensor signal for electrical disconnection.

9. The photovoltaic module according to claim 8, wherein at least the sensor of the trigger device is physically spaced apart from the safety circuit breaker.

10. The photovoltaic module according to claim 9, wherein the at least one sensor physically spaced apart from the safety circuit breaker is disposed in the vicinity of the connected consumer network.

11. The photovoltaic module according to claim 1, wherein the trigger device comprises at least one explosive cutout.

12. The photovoltaic module according to claim 1, wherein the trigger device and/or the cutout device are at least partly arranged in a module connection box of the photovoltaic module.

13. A combination of several photovoltaic modules in accordance with claim 1, wherein at least one cutout device of a photovoltaic module for disconnecting the respective associated power connection is functionally coupled with at least one such cutout device of at least one further photovoltaic module in such a way that upon activation of one of the cutout devices for disconnecting the respective associated power connection, the respective other cutout device for disconnecting the respective associated power connection is subsequently also activated, so that the combination of several photovoltaic modules is electrically disconnected when an activation of even one of the cutout devices has taken place.

14. The combination of several photovoltaic modules according to claim 13, wherein the functional coupling of the cutout device of a photovoltaic module to at least one further cutout device of at least one further photovoltaic module takes place via a discrete electric signal line.

15. The combination of several photovoltaic modules according to claim 13, wherein at least one cutout device of each photovoltaic module is connected via at least one respective discrete electric signal line to at least one cutout device of each further photovoltaic module of the combination of photovoltaic modules, with the at least one discrete electric signal line being electrically and functionally connected in such a way to a cutout device of a first photovoltaic module and being electrically and functionally connected in such a way to a cutout device of a second photovoltaic module that upon activation of one of the cutout devices for disconnecting the respective associated power connection that are interconnected via the signal line, the respective other cutout device for disconnecting the respective power connection associated to it is activated, so that the combination of several photovoltaic modules is electrically disconnected if an activation of even one of the cutout devices has taken place.

16. The combination of several photovoltaic modules according to claim 13, wherein the functional coupling of the cutout device of a photovoltaic module to at least one further cutout device of at least one further photovoltaic module takes place via a wireless interface.

17. A photovoltaic system comprising a combination of several photovoltaic modules according to claim 13 and a building electricity network for supplying a building with electric power, which is electrically supplied with electric power by the combination of several photovoltaic modules via its connection device, the photovoltaic system having integrated therein a status indicating device for indicating the measure of disconnecting the photovoltaic modules from the connection line electrically or by wireless communication, wherein the disconnection of the respective associated power connection from the building electricity network is executed in accordance with at least one of:
the status indicating device is implemented as a visual indicating device;
the status indicating device is implemented as a signal lamp;
the status indicating device is implemented as an LED;
the status indicating device is implemented as an acoustic indicating device; and
the status indicating device is implemented with a speech module,
wherein the status indicating device comprises a storage battery which is adapted to be charged by the photovoltaic modules during their normal operation.
